(19) United States
(12) Patent Application Publication
(10) Pub. No.: US 2026/0213942 A1
(43) Pub. Date: Jul. 23, 2026

(54) MODULE-LATTICE KEY ENCAPSULATION MECHANISM WITH ENCRYPTED ENTROPY INFORMATION

(71) Applicant: QUALCOMM Incorporated, San Diego, CA (US)

(72) Inventors: Joona Verneri KANNISTO, Salo (FI); Aseem BRAHMA, San Diego, CA (US)

(21) Appl. No.: 19/035,630

(22) Filed: Jan. 23, 2025

(51) Int. Cl. H04L 9/30; H04L 9/08; H04L 9/40

(52) U.S. Cl. CPC H04L 9/3093; H04L 9/0869; H04L 63/0435

(57) ABSTRACT

Disclosed are systems, apparatuses, processes, and computer-readable media for sharing encrypted entropy. For example, a method includes sampling, by a reference device, an entropy associated with the reference device; encrypting the entropy based on hardware information of the reference device; and transmitting a message including the encrypted entropy. In some aspects, a peer device may decrypt the encrypted entropy and generate a private key based on the entropy.

### FIELD

The present disclosure generally relates to key encapsulation for post-quantum cryptography. For example, aspects of the present disclosure relate to the Module-Lattice Key Encapsulation Mechanism (ML-KEM) with encrypted entropy information.

### BACKGROUND

Computing devices often employ various techniques to protect data. As an example, data may be subjected to encryption and decryption techniques in a variety of scenarios, such as writing data to a storage device, reading data from a storage device, writing data to or reading data from a memory device, encrypting and decrypting blocks and/or volumes of data, encrypting and decrypting digital content, performing inline cryptographic operations, etc. Such encryption and decryption operations are often performed, at least in part, using a security information asset, such as a cryptographic key, a derived cryptographic key, etc. Certain scenarios exist in which attacks are performed in an attempt to obtain such security information assets. Accordingly, it is often advantageous to implement systems and techniques to protect such security information assets.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, apparatuses, methods, computer readable medium, and circuits for performing a function. According to at least one example, a method includes: sampling, by a reference device, an entropy associated with the reference device; encrypting the entropy based on hardware information of the reference device; and transmitting a message including the encrypted entropy.

In another example, an apparatus for sharing encrypted entropy information is provided that includes a storage (e.g., a memory configured to store data, such as virtual content data, one or more images, etc.) and at least one processor (e.g., implemented in circuitry) coupled to the memory and configured to execute instructions and, in conjunction with various components (e.g., a network interface, a display, an output device, etc.), cause the apparatus to: sample, by a reference device, an entropy associated with the reference device; encrypt the entropy based on hardware information of the reference device; and transmit a message including the encrypted entropy.

Disclosed are systems, apparatuses, methods, computer readable medium, and circuits for generating private keys based on encrypted entropy information. According to at least one example, a method includes: sampling, by a reference device, an entropy associated with the reference device; encrypting the entropy based on hardware information of the reference device; and transmitting a message including the encrypted entropy.

Disclosed are systems, apparatuses, methods, computer readable medium, and circuits for performing a function. According to at least one example, a method is provided for performing a function. The method includes: receiving, by a peer device, a message including encrypted entropy; decrypting entropy from the encrypted entropy using hardware information of the peer device; and generating a private key based on the entropy.

In another example, an apparatus for performing a function is provided that includes a storage (e.g., a memory configured to store data, such as virtual content data, one or more images, etc.) and at least one processor (e.g., implemented in circuitry) coupled to the memory and configured to execute instructions and, in conjunction with various components (e.g., a network interface, a display, an output device, etc.), cause the apparatus to: receive, by a peer device, a message including encrypted entropy; decrypt entropy from the encrypted entropy using hardware information of the peer device; and generate a private key based on the entropy.

In some aspects, one or more of the apparatuses described herein is, is a part of, or includes a mobile device (e.g., a mobile telephone or so-called “smart phone”, a tablet computer, or other type of mobile device), a wearable device, an extended reality device (e.g., a virtual reality (VR) device, an augmented reality (AR) device, or a mixed reality (MR) device), a personal computer, a laptop computer, a video server, a television (e.g., a network-connected television), a vehicle (or a computing device or system of a vehicle), or other device. In some aspects, the apparatus includes at least one camera for capturing one or more images or video frames. For example, the apparatus can include a camera (e.g., an RGB camera) or multiple cameras for capturing one or more images and/or one or more videos including video frames. In some aspects, the apparatus includes a display for displaying one or more images, videos, notifications, or other displayable data. In some aspects, the apparatus includes a transmitter configured to transmit one or more video frame and/or syntax data over a transmission medium to at least one device. In some aspects, the processor includes a neural processing unit (NPU), a central processing unit (CPU), a graphics processing unit (GPU), or other processing device or component.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The preceding, together with other features and embodiments, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a block diagram illustrating an example computing system including a function module, in accordance with some aspects of the disclosure.

FIG. 2 is a flow diagram illustrating a process for generating a group encryption key;

FIG. 3 is a conceptual diagram illustrating a client device configured to generate encrypted entropy information for generating a group encryption key in accordance with some aspects of the disclosure;

FIG. 4 is a conceptual diagram illustrating a client device configured to generate a group encryption key from encrypted entropy information in accordance with some aspects of the disclosure;

FIG. 5 is a sequence diagram illustrating a group of devices generating group encryption keys based on encrypted entropy information in accordance with some aspects of the disclosure;

FIG. 6 is a flow diagram illustrating an example of a process for generating encrypted entropy information for generating a group key used in accordance with some aspects of the disclosure;

FIG. 7 is a flow diagram illustrating an example of a process for generating a group encryption key based on encrypted entropy information in accordance with some aspects of the disclosure; and

FIG. 8 is a diagram illustrating an example of a system for implementing certain aspects described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and descriptions are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

As previously mentioned, computing devices often employ various techniques to protect data. As an example, data may be subjected to encryption and decryption techniques in a variety of scenarios, such as writing data to a storage device, reading data from a storage device, writing data to or reading data from a memory device, encrypting and decrypting blocks and/or volumes of data, encrypting and decrypting digital content, performing inline cryptographic operations, etc. Encryption and decryption operations are often performed, at least in part, using a secƒforurity information asset, such as a cryptographic key, a derived cryptographic key, etc.

In some cases, group encryption can be used to securely communicate information within a group of users to ensure that only authorized members can access and interpret the messages. Non-limiting examples of group encryption includes group messaging, corporate communication, military communication, cloud communication amongst distributed assets, video conferencing, device management, healthcare, and so forth. For example, a device manufacturer may implement group communication to distribute secure assets such as firmware updates, security policies, and so forth.

Digital signature schemes allow for secure access to restricted data (e.g., often referred to as a message, which may be in the form of a document, an algorithm, a website, etc.). These schemes restrict access to the data by adversaries that cannot produce a valid digital signature for access to the data. Digital signature schemes typically employ various algorithms, which include a key generation algorithm, a signature generation algorithm, and a verification algorithm. During key generation, the key generation algorithm outputs a secret (e.g., private) key (sk) and a corresponding public key (pk). During signature generation, the signature generation algorithm, given a message (M) and a secret key (sk), produces a signature (σ). During verification, the verification algorithm, given the message (M), the secret key (sk), and the signature (σ), determines whether to grant or not grant access to the message (M).

Conventional encryption techniques, such as RSA and ECC, rely on mathematical problems such as factoring large numbers or solving discrete logarithms to ensure that the signatures cannot be forged without access to the private key. In essence, the probability of breaking the mathematical trapdoor problem should be negligible (less than 2⁻⁶⁴), even with access to computational resources so vast that they exceed the limits of thermodynamics in this universe. Furthermore, the property should hold against all anticipated advances in cryptology during the lifetime of the asset to be secured. However, quantum computers could efficiently solve these mathematical problems used in conventional encryption techniques using algorithms such as Shor's algorithm. Hence, when cryptographically relevant quantum computers become available, quantum computing processing techniques will break these classical conventional encryption techniques, rendering current public-key infrastructures insecure.

Post-Quantum Cryptography (PQC) is based on quantum-resistant mathematical foundations like lattice-based or hash-based cryptography and can provide the necessary security to protect data against quantum attacks. Transitioning to PQC ensures that sensitive information, including financial transactions and critical infrastructure communications, remains secure both now and in the future, even as quantum computing capabilities advance.

The National Institute of Standards and Technology (NIST) PQC Project is in the process of soliciting, evaluating, and standardizing quantum-resistant public-key cryptographic algorithms. A goal of the NIST Post-Quantum Cryptography Project is to provide new public-key cryptography standards that will specify one or more additional unclassified, publicly disclosed digital signatures, public-key encryption, and key-establishment algorithms that are available worldwide and are capable of protecting sensitive government and commercial information well into the foreseeable future, including after the advent of quantum computers. Non-limiting examples of PQC digital signature schemes include but are not limited to, the Dilithium signature scheme, the Racoon signature scheme, and the Provable Unbalanced Oil and Vinegar (PROV) signature scheme.

Another aspect of the PQC is the distribution of keys and other information to implement PQC using techniques designed to resist attacks from quantum computers. Federal Information Processing Standards (FIPS) defines various standards such as FIPS 203 for Module-Lattice-Based Key-Encapsulation Mechanism (ML-KEM) Standard FIPS, FIPS 204 for Module-Lattice-Based Digital Signature Standard, and FIPS 205 for Stateless Hash-based Digital Signature Standard.

ML-KEM is a framework for establishing shared secret keys between two parties communicating over an insecure channel for future-proofing data security. ML-KEM uses lattice-based cryptography, which are mathematical structures that extend the concepts of points to higher dimensions. Security in ML-KEM relies on difficult problems such as learning with errors, which are considered difficult for both classical and quantum computers. ML-KEM uses lattice-based cryptography to generate, encapsulate, and decapsulate keys to ensure shared secrets remain protected. However, FIPS compliance places requirements on how the private keys are generated. For example, the private key entropy should come from an approved source.

In one or more aspects, systems, apparatuses, processes (also referred to as methods), and computer-readable media (collectively referred to herein as “systems and techniques”) are described herein for generating encrypted entropy information. In some aspects, the encrypted entropy information can be distributed to allow some devices to generate a corresponding key that can be used in group communication. For example, the entropy information can be encrypted based on hardware information and allow peer devices having the same hardware information to decrypt and use a key import process in order to use the same private key.. In this manner, the peer devices can form a group and can join a mutual group based on using a shared group secret to import a private key generated by a group member, such as a private ML-KEM lattice used in PQC.

The systems and techniques described herein may be implemented by any type of system or device. One illustrative example of a system that can be used to implement the systems and techniques described herein is an apparatus, such as a computing device or a system or component of the computing device.

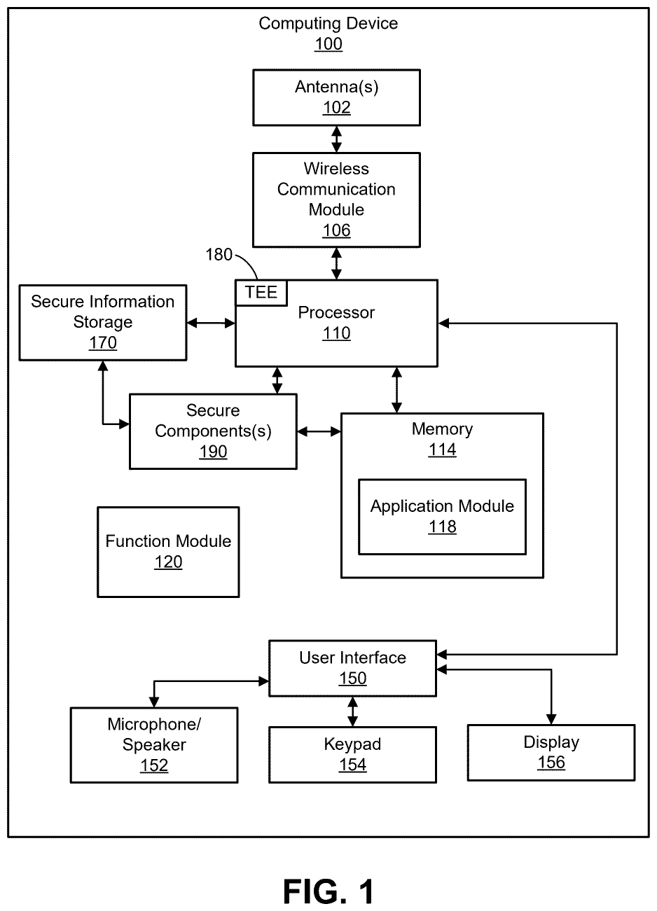

FIG. 1 is a block diagram illustrating an example computing device 100 that may implement the systems and techniques described herein. The computing device 100 may include but is not limited to, any of the following: one or more processors (e.g., components that include integrated circuitry, memory, input and output device(s) (not shown), non-volatile storage hardware, one or more physical interfaces, any number of other hardware components (not shown), and/or any combination thereof. Examples of computing devices include, but are not limited to, a mobile device (e.g., laptop computer, smart phone, personal digital assistant, tablet computer, automobile computing system, and/or any other mobile computing device), an Internet of Things (IoT) device, a server (e.g., a blade-server in a blade-server chassis, a rack server in a rack, etc.), a desktop computer, a storage device (e.g., a disk drive array, a fiber channel storage device, an Internet Small Computer Systems Interface (iSCSI) storage device, a tape storage device, a flash storage array, a network attached storage device, etc.), a network device (e.g., switch, router, multi-layer switch, etc.), a wearable device (e.g., a network-connected watch or smartwatch, or other wearable device), a robotic device, a smart television, a smart appliance, an extended reality (XR) device (e.g., augmented reality (AR), virtual reality (VR), etc.), any device that includes one or more System on Chips (SoCs), and/or any other type of computing device with the aforementioned requirements. In one or more examples, any or all of the aforementioned examples may be combined to create a system of such devices, which may collectively be referred to as a computing device. Other types of computing devices may be used without departing from the scope of examples described herein.

As illustrated, the computing device 100 may include one or more antennas 102, one or more wireless communication modules 106, a processor 110, memory 114, application module 118, a function module 120, user interface 150, microphone/speaker 152, keypad 154, display 156, secure information storage 170, trusted execution environment 180, and secure components 190.

As shown, the computing device 100 may include one or more wireless communication modules 106 that may be connected to one or more antennas 102. The one or more wireless communication modules 106 comprise suitable devices, circuits, hardware, and/or software for communicating with and/or detecting signals to/from an access point, a network, a base station, and/or directly with other wireless devices within a network.

In some implementations, the one or more wireless communication modules 106 may comprise a CDMA communication system suitable for communicating with a CDMA network of wireless base stations. In some implementations, the wireless communication system may comprise other types of cellular telephony networks, such as, for example, TDMA, GSM, WCDMA, LTE, NR, and the like. Additionally, any other type of wireless networking technologies may be used, including, for example, WiMax (802.16), Wi-Fi (802.11), and the like.

The processor(s) (also referred to as a controller) 110 may be connected to the one or more wireless communication modules 106. The processor 110 may include one or more microprocessors, microcontrollers, and/or digital signal processors that provide processing functions, as well as other calculation and control functionality. The processor 110 may be coupled to storage media (e.g., memory 114) for storing data and software instructions for executing programmed functionality within the mobile device. The memory 114 may be on-board the processor 110 (e.g., within the same IC package), and/or the memory may be external memory to the processor and functionally coupled over a data bus.

A number of software engines and data tables may reside in memory 114 and may be utilized by the processor 110 in order to manage communications, perform positioning determination functionality, and/or perform device control functionality. In some cases, the memory 114 may include an application module 118. It is to be noted that the functionality of the modules and/or data structures may be combined, separated, and/or be structured in different ways depending upon the implementation of the computing device 100.

The application module 118 may include a process running on the processor 110 of the computing device 100, which may request data from one of the other modules of the computing device 100. Applications typically run within an upper layer of the software architectures and may be implemented in a rich execution environment of the computing device 100, and may include indoor navigation applications, shopping applications, financial services applications, social media applications, location aware service applications, etc.

As illustrated, the computing device 100 can include a function module 120. In some cases, the function module 120 can be incorporated with one or more of the processor 110, secure information storage 170, trusted execution environment 180, or secure components 190. In some cases, the function module 120 can include a cryptography hash function or an error correcting code. In one or more examples, the cryptography hash function is a Secure Hash Algorithm (SHA), such as SHA-3. The function module 120 can be used to perform a function (e.g., a cryptography hash function or an error correcting code) on a matrix generated by the expansion of a private key during the key generation and/or signature generation processes of digital signature schemes, such as the Dilithium signature scheme, the Racoon signature scheme, and the PROV signature scheme.

In FIG. 1, in some examples, the computing device 100 includes the secure information storage 170. In some examples, the secure information storage 170 can be any storage device configured to store security information assets (e.g., cryptographic keys, metadata, etc.). For instance, the secure information storage 170 is where security information assets are stored and initially obtained from when needed for use on a computing device (e.g., for encryption and/or decryption of data). In some cases, the secure information storage 170 can include a key store or a key table. Examples of secure information storage 170 include, but are not limited to, various types of read-only memory, one-time programmable memory devices (e.g., one time programmable fuses or other types of one time programmable memory devices), non-volatile memory, etc. The secure information storage 170 may be operatively connected to the trusted execution environment 180 and/or the secure components 190. Although FIG. 1 shows the computing device 100 as including a single secure information storage 170, the computing device 100 may include any number of secure information storages without departing from the scope of examples described herein.

The processor 110 may include a trusted execution environment 180. The trusted execution environment 180 may also be referred to as a trusted management environment, trust zones, trusted platform modules, or the like. The trusted execution environment 180 can be implemented as a secure area of the processor 110 that can be used to process and store sensitive data in an environment that is segregated from the rich execution environment in which the operating system and/or applications (such as those of the application module 118) may be executed. The trusted execution environment 180 can be configured to execute secure applications (also referred to as trusted applications) that provide end-to-end security for sensitive data by enforcing confidentiality, integrity, and protection of the sensitive data stored therein. The trusted execution environment 180 can be used to store encryption keys, access tokens, and other sensitive data.

The computing device 100 may include one or more secure components 190. In some cases, the secure components 190 can be referred to as trusted components, secure elements, trusted elements, or the like. The computing device 100 may include the secure components 190 in addition to or instead of the trusted execution environment 180. The secure components 190 can comprise autonomous and tamper-resistant hardware that can be used to execute secure applications and the confidential data associated with such applications. The secure components 190 can be used to store encryption keys, access tokens, and other sensitive data. The secure components 190 can comprise a Near Field Communication (NFC) tag, a Subscriber Identity Module (SIM) card, or other type of hardware device that can be used to securely store data. The secure components 190 can be integrated with the hardware of the computing device 100 in a permanent or semi-permanent fashion or may, in some implementations, be a removable component of the computing device 100 that can be used to securely store data and/or provide a secure execution environment for applications.

Examples of secure applications that may be performed by the computing device 100, processor 110, secure information storage 170, trusted execution environment 180, secure components 190, and/or any combination thereof include, but are not limited to, encrypting data, decrypting data, key derivation, performing data integrity verification, and performing authenticated encryption and decryption. In some examples, the computing device 100 and/or portions thereof can be configured to perform the various cryptographic service types by being configured to execute one or more cryptographic algorithms. As an example, to perform encryption and decryption, one or more components (e.g., secure information storage 170, trusted execution environment 180, secure components 190) of the computing device 100 may be configured to execute one or more of the Advanced Encryption Standard XOR-encrypt-XOR Tweakable Block Ciphertext Stealing (AES-XTS) algorithm, the AES-Cipher Block Chaining (AES-CBC) algorithm, the AES-Electronic Codebook (AES-EBC) algorithm, the Encrypted Salt-Sector Initialization Vector-AES-CBC (ESSIV-AES-CBC) algorithm, etc., including any variants of such algorithms (e.g., 128 bits, 192 bits, 256 bits, etc.). As another example, to perform integrity verification, one or more components of the computing device 100 may be configured to execute a hash algorithm such as, for example, the one or more members of the SHA family of hash algorithms. As another example, to perform authenticated encryption, one or more components of the computing device 100 may be configured to perform a digital signature scheme algorithm (e.g., such as for the Dilithium signature scheme, the Racoon signature scheme, and the PROV signature scheme). In some aspects, one or more components of the computing device 100 may be configured to execute any other cryptographic algorithms without departing from the scope of examples described herein.

The computing device 100 may further include a user interface 150 providing suitable interface systems, such as a microphone/speaker 152, a keypad 154, and/or a display 156 that allows user interaction with the computing device 100. The microphone/speaker 152 can provide for voice communication services (e.g., using the one or more wireless communication modules 106). The keypad 154 may comprise suitable buttons for user input. The display 156 may include a suitable display, such as, for example, a backlit LCD display, and may further include a touch screen display for additional user input modes.

While FIG. 1 shows a certain number of components in a particular configuration, one of ordinary skill in the art will appreciate that the computing device 100 may include more components or fewer components, and/or components arranged in any number of alternate configurations without departing from the scope of examples described herein. Additionally, although not shown in FIG. 1, one of ordinary skill in the art will appreciate that the computing device 100 may execute any amount or type of software or firmware (e.g., bootloaders, operating systems, hypervisors, virtual machines, computer applications, mobile device apps, etc.). Accordingly, examples disclosed herein should not be limited to the configuration of components shown in FIG. 1. The components shown in FIG. 1 may or may not be discrete components. In some aspects, one or more of the components can be combined into different hardware elements, implemented in software, and/or otherwise implemented using software and/or hardware. As used herein, the term device may be a discrete component or apparatus, or may not be a discrete component. In some aspects, other devices can exist within, be part of, and/or utilize the same hardware components as a device.

As previously mentioned, computing devices typically employ various techniques to protect data. As an example, data may be subjected to encryption and decryption techniques in a variety of scenarios (e.g., writing data to a storage device, reading data from a storage device, writing data to or reading data from a memory device, encrypting and decrypting blocks and/or volumes of data, encrypting and decrypting digital content, performing inline cryptographic operations, etc.). Such encryption and decryption operations are usually performed, at least in part, using a security information asset, such as a cryptographic key, a derived cryptographic key, etc.

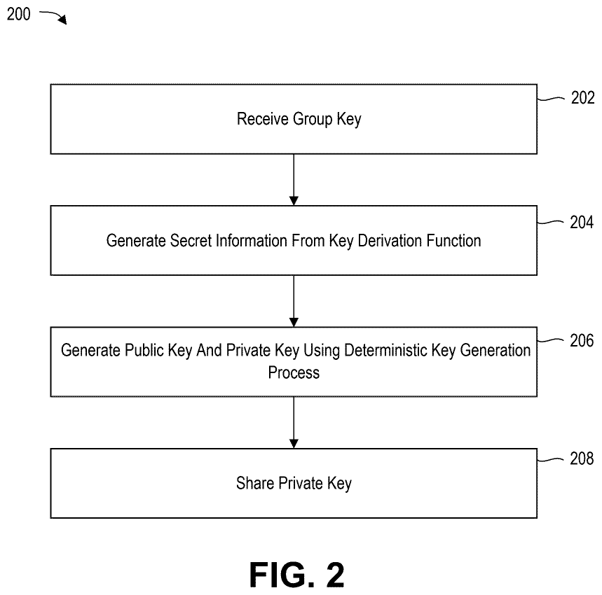

FIG. 2 is a flow diagram 200 illustrating a client device configured to generate and share a private key for group encryption based on conventional sharing techniques. In some aspects, alternatives to a group key include distinct public key pairs per device. However, distinct public keys do not scale because the number of devices that should be able to access the same asset can be very large (e.g., millions). In some aspects, a reference device may be configured to generate a public key, which is then shared with corresponding devices.

For example, at block 202, the reference device (e.g., the computing device 100 in FIG. 1) may receive a group key with information pertaining how to generate a private key and a corresponding public key. In some aspects, the group key includes various information pertaining to the device such as fuse, software information, images, and so forth.

At block 204, the reference device is configured to generate secret information from the group key using a key derivation function (KDF). In some aspects, a KDF includes a cryptographic algorithm that generates one or more secret keys from the group key. For example, the group key may include a short secret such as a password, master key, or shared secret. The KDFs may ensure that derived keys are robust and unpredictable to enhance the security of cryptographic systems. For example, the group key may include information identifying specific information in the reference device (e.g., bits encoded in hardware fuses, etc.), salt, and other random information. In some cases, the group key may be derived based on hardware fuse information that identifies a public key for an authorized user or custodian of the device.

At block 206, the reference device is configured to generate a public key and a private key using a deterministic key generation process. In some aspects, a deterministic key generation process generates cryptographic keys in a predictable manner based on a specific input, such as a passphrase or seed value. A deterministic key generation process ensures that the same input always produces the same key and enables reproducibility without storing the generated keys. Deterministic methods offer advantages like easier key recovery and portability while maintaining security as long as the initial input remains confidential.

At block 208, the reference device is configured to share the public key with other peer devices in the group. In some aspects, the reference device encrypts and transmits the public key to other peer devices. In some aspects, the peer devices receive the group key and the public key and have the source key material to derive the private key using the deterministic key generation process.

In some aspects, FIPS-203 restricts the deterministic key generation process to preclude sharing of key generation materials to private functions that cannot be exposed to an API. In this case, the flow diagram 200 illustrated in FIG. 2 is not FIPS-203 compliant because the key generation materials are shared (e.g., the public key) with peer devices to derive the private key. In some aspects, failure to comply with FIPS-203 can undermine data security by exposing cryptographic implementations to vulnerabilities and may potentially lead to unauthorized access, data breaches, and regulatory penalties for organizations handling sensitive information.

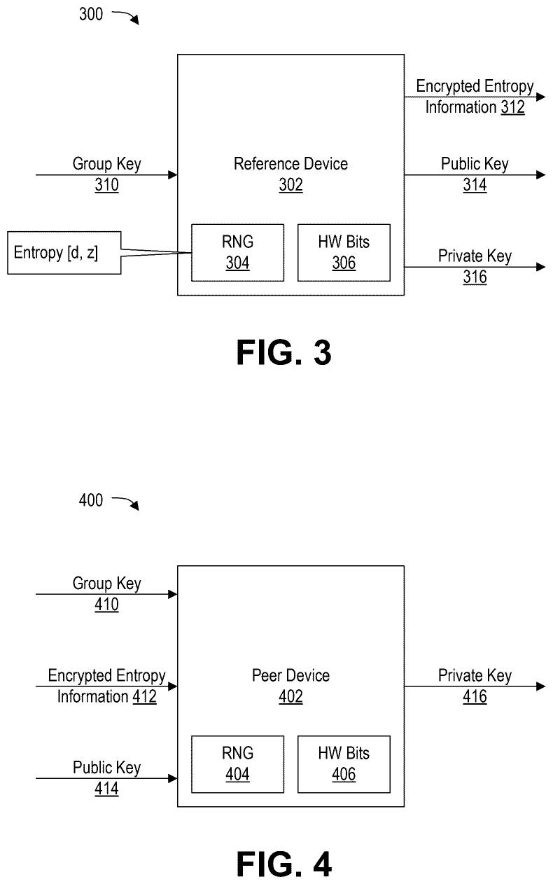

FIG. 3 is a conceptual diagram 300 illustrating a reference device 302 configured to generate encrypted entropy information for generating a group key in ML-KEM in accordance with some aspects of the disclosure. In some aspects, a reference device 302 may be a reference device for generating entropy that is used to derive keys at other peer devices. The reference device 302 or a component thereof (e.g., a processor, etc.) is configured to generate, encrypt, and share entropy information and a public key with peer devices. In some cases, the peer devices may be able to decrypt the encrypted entropy information and derive a private key based on the entropy information. For example, the entropy information may be encrypted using a FIPS-203 compliant algorithm. Another peer device may decrypt the entropy information and then securely derive the same private keys using the entropy information and the public key. In some cases, the group key provided to each peer device may also be used to generate the private keys.

In some aspects, the reference device 302 may include a random number generator (RNG) 304 and hardware bits 306 that are encoded with various information. The RNG 304 may be configured to generate and output entropy information, which corresponds to random or pseudorandom information within the reference device 302, and can be used to generate encryption keys. Entropy is unpredictable data from physical or environmental sources (e.g., thermal noise or user input) that is used to produce random numbers and ensure that the random numbers are statistically unpredictable and secure. Entropy can be provided from multiple sources associated with the reference device 302 to ensure true randomness. Non-limiting examples of entropy include thermal noise, system states (e.g., input), atmospheric noise, radio noise, and so forth. In some aspects, the RNG 304 may generate a pair of entropy values (e.g., [d, z]) based on a request, and the entropy values can be used by the RNG 304 or another device to generate a random number. In some cases, the RNG 304 may provide the entropy values [d, z] when generating a random numbers (e.g., the RNG 304 returns a tuple including the random number and the entropy values [d, z]).

In some cases, entropy may be expressed as pairs (e.g., source and output) when describing entropy sources or evaluating the relationship between an input (raw data) and processed randomness. In other cases, entropy may be expressed as two different values to provide random source numerical diversity to increase randomness (e.g., entropy value d is associated with thermal noise and entropy value z is associated with noise associated with a wireless receiver.

The hardware bits 306 are configured to store configuration settings or security keys to enable functions such as hardware-level encryption, attestation functions, or other secure boot processes. The hardware bits 306 may be configured into hardware level components during manufacturing and may only be accessed by the root of trust of the reference device 302. For example, the hardware bits 306 may only be directly accessed based on a request into the root of trust (e.g., a circuit within the reference device 302). For example, a processor of the reference device 302 may request a root of trust to encrypt or decrypt information using a symmetric encryption key based on hardware information, and the hardware information can be a reference value that identifies a value stored within the root of trust. The hardware bits 306 ensure critical information remains immutable, enhancing security and preventing unauthorized tampering. In some cases, the hardware bits 306 may include fuses in the event cryptographic keys are compromised to add additional layers of security.

In some aspects, the reference device 302 is configured to receive a group key 310 including information that can be used to securely generate a public key and private key for group communications. For example, the group key 310 may include the hardware information that refers (e.g., a reference value) to a symmetric encryption key stored in the root of trust. The group key 310 can also include other information used in a deterministic process such as a salt or a sequence that the reference device 302 may use a deterministic key derivation function to further ambiguate the information.

In some aspects, the reference device 302 is configured to encrypt the entropy information (e.g., the entropy pair) based on the hardware information. For example, the reference device 302 may use a FIPS-approved key wrapping algorithm to generate the encrypted entropy information 312. In some aspects, the reference device 302 may use a private symmetric group key stored in the hardware bits 306 (or derived from the hardware bits 306 using a deterministic key generation process) to wrap the entropy information and output the encrypted entropy information 312. In some aspects, the reference device 302 is configured to provide the encrypted entropy information 312 to other peer devices, such as via direct transmission or based on distributing the encrypted entropy information 312 from an infrastructure node

In some aspects, the reference device 302 may also be configured to generate the public key 314 and the private key 316 using a deterministic key derivation function based on the entropy information.

In some aspects, the reference device 302 may not provide the public key 314 to other peer devices. For example, as described below, peer devices of the reference device 302 may be configured to derive the private key and the public key in a group communication based on the encrypted entropy information 312. For example, the peer devices receive encrypted entropy information and may generate a private key that has value equality to private key 316 based on the encrypted entropy information 312. In one example, corresponding hardware information may be used to decrypt or unwrap the encrypted entropy information 312. In some aspects, the private key 316 is not shared with other peer devices based on compliance with FIPS-203. In some aspects, the reference device 302 may provide the public key 314 to other peer devices.

FIG. 4 is a conceptual diagram illustrating a client device configured to generate a group encryption key from encrypted entropy information in accordance with some aspects of the disclosure. In some aspects, a peer device 402 may be a peer device of the reference device (e.g., the reference device 302 in FIG. 3). The peer device 402 (or a constituent component thereof such as a processor, etc.) may include various components such as an RNG 404 and hardware bits 406 that are approved or deemed equivalent to the corresponding features of a reference device (e.g., the reference device 302 of FIG. 3). For example, the random number generator (RNG) 304 and the RNG 404 are substantially equivalent and may be configured to generate a deterministic result (e.g., a deterministic key generation function) based on an input entropy.

The peer device 402 may be configured to receive a group key 410 (e.g., corresponding to the group key 310 of FIG. 3) and encrypted entropy information 412 (e.g., the encrypted entropy information 312 of FIG. 3). In some aspects, the peer device 402 is configured to decrypt the encrypted entropy information 412 to yield the entropy information (e.g., entropy pair [d, z] in FIG. 3, etc.) based on hardware information. For example, the group key 410 may include hardware information that identifies a symmetrical encryption key that is stored in a root of trust (e.g., the symmetrical encryption key may be stored in the hardware bits 406) or can be derived from the hardware bits 406 (e.g., using a deterministic key generation function). For example, the reference device 302 and the peer device 402 can be devices having a substantially similar configuration, such as a processor or other integrated circuit within an SoC that is encoded with a symmetrical encryption key in the hardware bits (e.g., the hardware bits 306 and the hardware bits 406) during manufacturing. In this case, the peer device 402 can use the symmetrical encryption key and decrypt the encrypted entropy information 412 to yield the entropy information (e.g., entropy [d, z]).

In some aspects, the peer device may also receive the public key 414 along with the encrypted entropy information 412. In this case, the public key 414 can be used without concern about leaking private asymmetric information.

In some cases, the peer device 402 use may the decrypted entropy information in a connection with a deterministic key generation function to derive the asymmetric private key 416. For example, the peer device 402 may use entropy information and a deterministic key generation function to generate the private key 416. In some aspects, the RNG 404 may be used to generate a random number from the entropy information, which is then used to generate the private key 416. For example, the RNG 404 may use the entropy and execute at least one random number generation process that yields a deterministic result when entropy and at least one other parameter are provided (e.g., a salt, a public key, etc.). For example, the reference device 302 and the peer device 402 can be from a family of devices that share the symmetric encryption key and have equivalent RNGs. The RNGs can be approved by a device manufacturer to form a communication group associated with a specific device configuration (e.g., a stock keeping unit). In some aspects, the private key 416 has value equality with the private key 316 in FIG. 3 and the peer device 402 does not receive information deemed private and complies with FIPS-203.

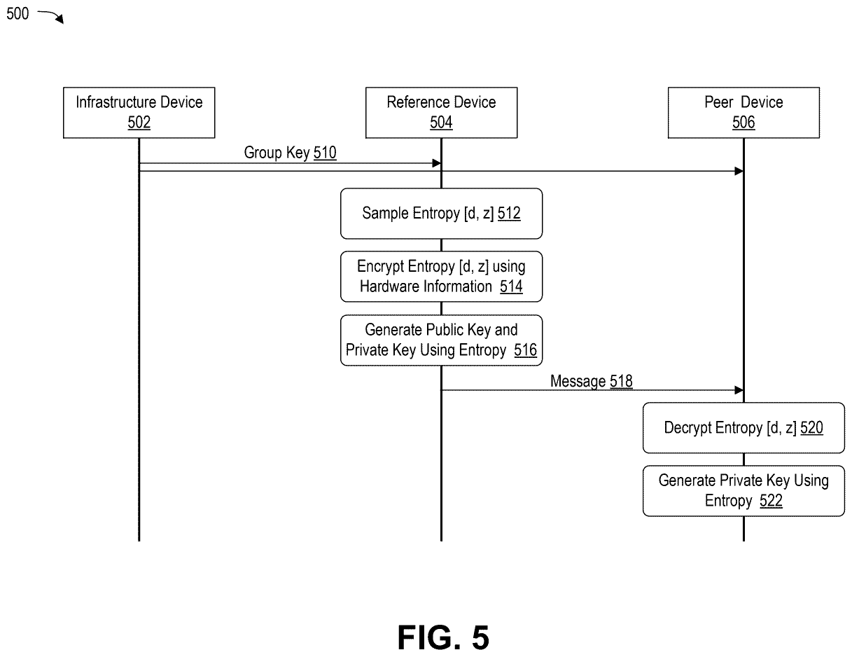

FIG. 5 is a sequence diagram 500 illustrating a group of devices generating group encryption keys based on encrypted entropy information in accordance with some aspects of the disclosure. The group of devices includes an infrastructure node 502, a reference device 504, and a peer device 506. In some aspects, the infrastructure node 502 provides group key information 510 to both the reference device 504 and the peer device 506.

At block 512, the reference device 504 is configured to sample entropy from an RNG of the reference device 504 and may generate a public key based on the sampled entropy. In some cases, the entropy may be an entropy pair [d, z]. In some aspects, the reference device 504 and the peer device 506 have equivalent RNGs and can implement a deterministic random function based on identical input parameters (e.g., an entropy pair, a salt, etc.). In some cases, the public key and the sampling and public key generation can be a single function execution that returns a tuple including the public key and the entropy information (e.g., entropy [d, z]). In other examples, block 514 may include a first function call to sample the entropy to yield the entropy information and then a second function call to generate a random number based on the entropy.

At block 514, the reference device 504 is configured to encrypt the sampled entropy using hardware information. For example, the reference device 504 may store a symmetric encryption key in hardware bits. In some aspects, the symmetric encryption key may only be made available based on an authentication request into a trusted execution environment or other secure environment. In such cases, the operations at block 514 are operated keep within the kernel and are not surfaced to user space for security concerns. The reference device 504 may use the symmetric encryption key to wrap the sampled entropy using, for example, a FIPS approved key wrapping algorithm.

At block 516, the reference device 504 may generate the public key and the private key for group encrypted communication by using the entropy information. In some aspect, block 516 is illustrated separately for clarity of explanation and may be part of other processes described above.

The reference device 504 may transmit a message 518 to the peer device 506 including the public key and the encrypted entropy information. At block 520, the peer device 506 is configured to decrypt the encrypted entropy information into the sampled entropy (e.g., entropy [d, z]). For example, the peer device may use hardware information included in the group key to decrypt the encrypted entropy information. As noted above, the hardware information can be a reference to a symmetric encryption key stored in hardware that is accessible at the root of trust, and can decrypt the encrypted entropy information based on the reference device 504 and the peer device 506 having an identical symmetric encryption key, which is encoded into hardware.

At block 522, the peer device 506 is configured to generate the private key based on the entropy information (e.g., entropy [d, z]). After the private key is generated, which has value equality private key generated by the reference device 504, the peer device 506 may be able to validate signatures and communications. In some aspects, the reference device 504 and the peer device 506 limit usage of the symmetric encryption key to validate private information. In this manner, the reference device 504 and the peer device 506 can receive information from other sources and validate communications associated with the group without concern about leaking private information.

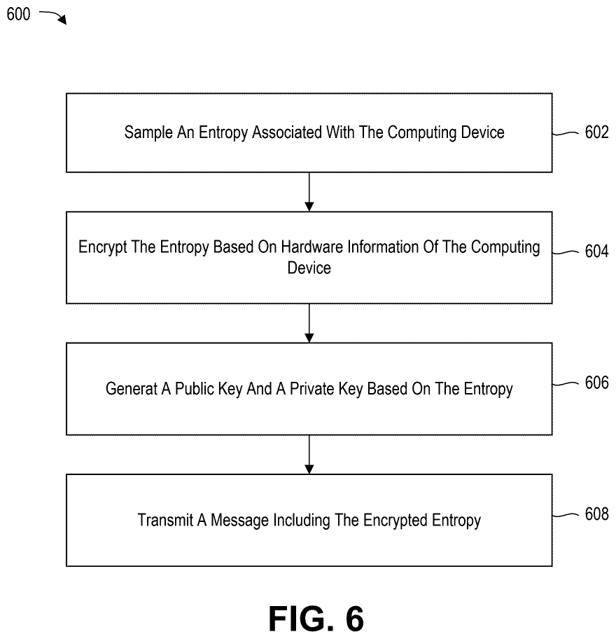

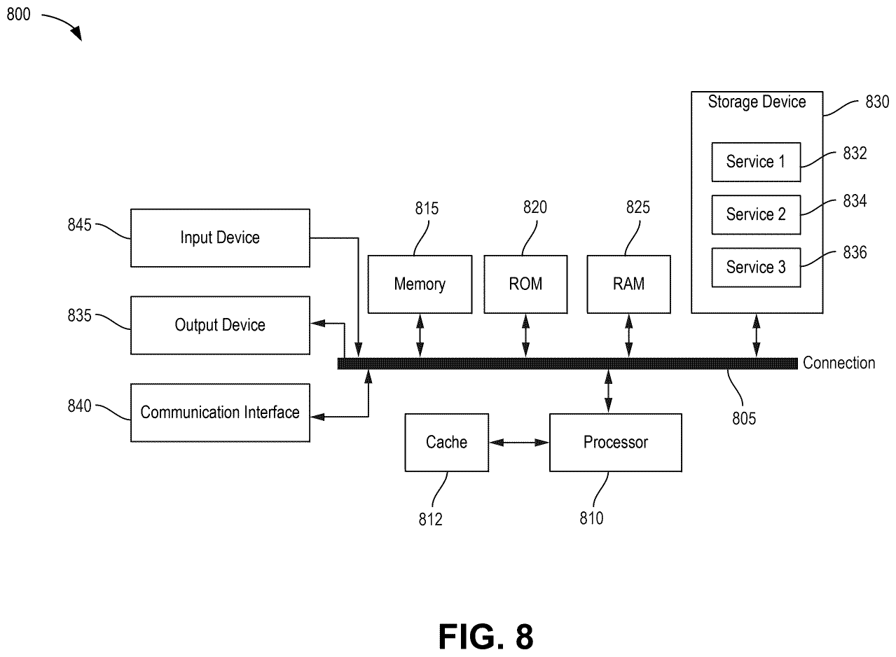

FIG. 6 is a flow diagram illustrating an example of a process 600 for generating encrypted entropy information for generating a group key used in accordance with some aspects of the disclosure. The process 600 can be performed by a computing device (or apparatus) or a component (e.g., one or more chipsets, a system-on-chip (SoC), one or more processors such as one or more central processing units (CPUs), graphics processing units (GPUs), digital signal processors (DSPs), neural processing units (NPUs), neural signal processors (NSPs), microcontrollers, ASICs, FPGAs, programmable logic devices, discrete gates or transistor logic components, discrete hardware components, etc., an ML system such as a neural network model, any combination thereof, and/or other component or system) of the computing device. The operations of the process 400 may be implemented as software components that are executed and run on one or more processors (e.g., CPU, GPU, DSP, NPU or neural engine, SoC, the processor 810 of FIG. 8, and/or other processor(s)).

In some aspects, the computing device may receive a group key that includes various information for generating a group communications. In one aspect, the group key may include hardware information that refers to value stored within the computing device (e.g., bits encoded into a root of trust or some other integrated circuit or module). For example, the hardware information may be a reference value that refers to a symmetric encryption key that each device associated with other peer devices may also be manufactured with.

At block 602, the computing device samples an entropy associated with the computing device. For example, the computing device may use a request the RNG to provide at least one entropy value for use in executing a key generation or random number process. In some aspects, the entropy may be a pair of values that provide random diversity and each value can be 32 byte numbers.

At block 604, the computing device may encrypt the entropy information based on the hardware information of the computing device. In some aspects, as part of block 604, the computing device may perform a key wrap function that encrypts entropy information. For example, the entropy information may be a pair of entropy information and stored as a tuple, and the key wrap function is used to encrypt the structure and both values of the entropy information. The key wrap function may be compliant with various FIPS standards such as FIPS-203.

At block 606, the computing device may generate a private key and a public key based on the entropy information. For example, the private key and the public key may form an asymmetric encryption key pair used for communications amongst a group of peer devices. In some aspects, the private key and the public key may be ML-KEM lattices.

At block 608, the computing device may transmit a message including the encrypted entropy. In some cases, the message may include the public key generated at block 606.

In some aspects, the computing device may communicate with a plurality of peer devices based on the public key and the private key. For example, the communication can be each peer device receiving information from an infrastructure node, such as a firmware image for updating the computing device. In some aspects, the communication may include transmitting encrypted information to other peer devices. Each of the plurality of peer devices includes the hardware information and can decrypt the encrypted entropy information. The encrypted entropy information may be significantly smaller than corresponding ML-KEM lattices.

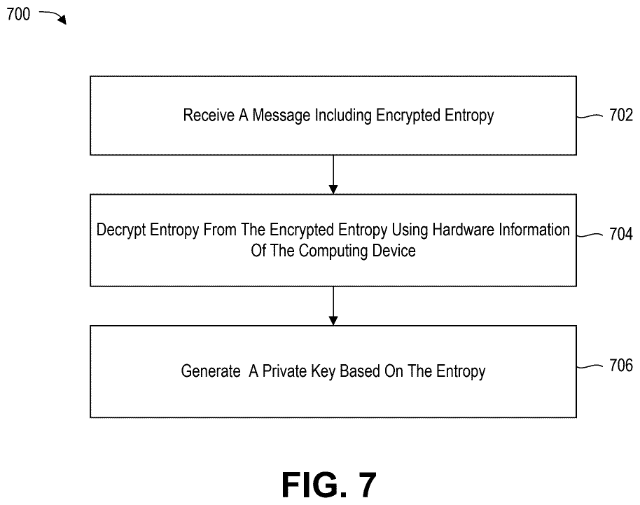

FIG. 7 is a flow diagram illustrating an example of a process 700 for generating a group encryption key based on encrypted entropy information in accordance with some aspects of the disclosure. The process 700 can be performed by a computing device (or apparatus) or a component (e.g., one or more chipsets, a system-on-chip (SoC), one or more processors such as one or more central processing units (CPUs), graphics processing units (GPUs), digital signal processors (DSPs), neural processing units (NPUs), neural signal processors (NSPs), microcontrollers, ASICs, FPGAs, programmable logic devices, discrete gates or transistor logic components, discrete hardware components, etc., an ML system such as a neural network model, any combination thereof, and/or other component or system) of the computing device. The operations of the processes 600 and 700 may be implemented as software components that are executed and run on one or more processors (e.g., CPU, GPU, DSP, NPU or neural engine, SoC, the processor 810 of FIG. 8, and/or other processor(s)).

The computing device may receive group information identifying the hardware information. For example, the hardware information may include a reference to a value stored computing device in the secure manner, such as bits encoded in a root of trust. In some cases, the value stored in the bits encoded in the root of trust may be a symmetric encryption key.

At block 702, the computing device may receive a message including encrypted entropy. In some aspects, the message may also include a public key generated by a reference device (e.g., the/504 of FIG. 5).

At block 704, the computing device may decrypt entropy from the encrypted entropy using the hardware information of the peer device. For example, the computing device may provide the hardware information and the encrypted entropy to the root of trust, which decrypts the encrypted entropy into entropy values (e.g., entropy [d, z]) without exposing the encryption key identified by the hardware information. In some aspects, the decryption algorithm may be compliant with various FIPS standards such as FIPS-203.

At block 706, the computing device may generate a private key based on the entropy. For example, the computing device may, at part of block 706, provide the entropy to a random number generator, which generates a random number, and then use a deterministic key generation function to generate the private key. In some aspects, the private key and the public key may comprises ML-KEM lattices. The entropy information may be smaller than ML-KEM lattices.

After generating the private key, the computing device may communicate with a plurality of peer devices based on at least one of the public key and the private key. Each device included in the plurality of peer device may include equivalent hardware information to derive the same private key. In this manner, the computing device and associated peer devices may each separately derive the private key to allow communication amongst the group without sharing private information and thereby comport with FIPS processes.

In some cases, the computing device of processes 600 and 700 may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the Wi-Fi (802.11x) standards, data according to the Bluetooth™ standard, data according to the Internet Protocol (IP) standard, and/or other types of data.

The components of the computing device of processes 600 and 700 can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The processes 600 and 700 are illustrated as a logical flow diagram, the operations of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes 600 and 700 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 8 is a block diagram illustrating an example of a computing system 800, which may be employed for countermeasures against fault attacks on PQC schemes (e.g., digital signature schemes). In particular, FIG. 8 illustrates an example of computing system 800, which can be for example any computing device making up internal computing system, a remote computing system, a camera, or any component thereof in which the components of the system are in communication with each other using connection 805. Connection 805 can be a physical connection using a bus, or a direct connection into processor 810, such as in a chipset architecture. Connection 805 can also be a virtual connection, networked connection, or logical connection.

In some aspects, computing system 800 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 800 includes at least one processing unit (CPU or processor) 810 and connection 805 that communicatively couples various system components including system memory 815, such as read-only memory (ROM) 820 and random access memory (RAM) 825 to processor 810. Computing system 800 can include a cache 812 of high-speed memory connected directly with, in close proximity to, or integrated as part of processor 810.

Processor 810 can include any general purpose processor and a hardware service or software service, such as services 832, 834, and 836 stored in storage device 830, configured to control processor 810 as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction, computing system 800 includes an input device 845, which can represent any number of input mechanisms, such as a microphone for speech, a touch-sensitive screen for gesture or graphical input, keyboard, mouse, motion input, speech, etc. Computing system 800 can also include output device 835, which can be one or more of a number of output mechanisms. In some instances, multimodal systems can enable a user to provide multiple types of input/output to communicate with computing system 800.

Computing system 800 can include communications interface 840, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 840 may also include one or more range sensors (e.g., LiDAR sensors, laser range finders, RF radars, ultrasonic sensors, and infrared (IR) sensors) configured to collect data and provide measurements to processor 810, whereby processor 810 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 840 may also include one or more Global Navigation Satellite System (GNSS) receivers or transceivers that are used to determine a location of the computing system 800 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 830 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 830 can include software services, servers, services, etc., that when the code that defines such software is executed by the processor 810, it causes the system to perform a function. In some aspects, a hardware service that performs a particular function can include the software component stored in a computer-readable medium in connection with the necessary hardware components, such as processor 810, connection 805, output device 835, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but may have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as RAM such as synchronous dynamic random access memory (SDRAM), ROM, non-volatile random access memory (NVRAM), EEPROM, flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more DSPs, general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative Aspects of the present disclosure include:

Aspect 1. A computing device for sharing encrypted entropy information. The computing device includes at least one memory and at least one processor coupled to the at least one memory and configured to: sample, by a reference device, an entropy associated with the reference device; encrypt the entropy based on hardware information of the reference device; and transmit a message including the encrypted entropy.

Aspect 2. The computing device of Aspect 1, wherein the at least one processor is configured to: communicate with the plurality of peer devices based on at least one of a public key and a private key, wherein each of the plurality of peer devices includes the hardware information.

Aspect 3. The computing device of any of Aspects 1 to 2, wherein the hardware information comprises an encryption key stored in an integrated circuit of the reference device.

Aspect 4. The computing device of Aspect 3, wherein the encryption key is symmetric.

Aspect 5. The computing device of any of Aspects 1 to 4, wherein an algorithm used to encrypt the entropy is compliant with Federal Information Processing Standards (FIPS).

Aspect 6. The computing device of any of Aspects 1 to 5, wherein the at least one processor is configured to: generate a private key and a public key based on the entropy based on providing the entropy to a random number generator of the reference device.

Aspect 7. The computing device of Aspect 6, wherein the private key and the public key comprise Module-Lattice Key Encapsulation Mechanism (ML-KEM) lattices.

Aspect 8. The computing device of any of Aspects 1 to 7, wherein the at least one processor is configured to: receive group information including the hardware information.

Aspect 9. The computing device of any of Aspects 1 to 8, wherein the entropy comprises a pair of entropy values.

Aspect 10. The computing device of Aspect 9, wherein the entropy values are smaller than ML-KEM lattices.

Aspect 11. A computing device for generating private keys based on encrypted entropy information. The computing device includes at least one memory and at least one processor coupled to the at least one memory and configured to: receive, by a peer device, a message including encrypted entropy; decrypt entropy from the encrypted entropy using hardware information of the peer device; and generate a private key based on the entropy.

Aspect 12. The computing device of Aspect 11, wherein the at least one processor is configured to: communicate with a plurality of peer devices based on at least one of a public key and the private key, wherein each of the plurality of peer devices includes the hardware information.

Aspect 13. The computing device of any of Aspects 11 to 12, wherein the hardware information includes an encryption key stored in an integrated circuit of the peer device.

Aspect 14. The computing device of Aspect 13, wherein the encryption key is symmetric.

Aspect 15. The computing device of any of Aspects 11 to 14, wherein an algorithm used to decrypt the encrypted entropy is compliant with Federal Information Processing Standards (FIPS).

Aspect 16. The computing device of any of Aspects 11 to 15, wherein the at least one processor is configured to: provide the entropy to a random number generator of the peer device.

Aspect 17. The computing device of any of Aspects 11 to 16, wherein the private key and a corresponding public key comprise Module-Lattice Key Encapsulation Mechanism (ML-KEM) lattices.

Aspect 18. The computing device of Aspect 17, wherein the at least one processor is configured to: receive group information identifying the hardware information.

Aspect 19. The computing device of Aspect 18, wherein the entropy comprises a pair of entropy values.

Aspect 20. The computing device of Aspect 19, wherein the entropy values are smaller than ML-KEM lattices.

What is claimed is:

1. An apparatus for sharing encrypted entropy information, comprising:
at least one memory; and
at least one processor coupled to the at least one memory and configured to:
sample, by a reference device, an entropy associated with the reference device;
encrypt the entropy based on hardware information of the reference device; and
transmit a message including the encrypted entropy.

2. The apparatus of claim 1, wherein the at least one processor is configured to:
communicating with a plurality of peer devices based on at least one of a public key and a private key, wherein each of the plurality of peer devices includes the hardware information.

3. The apparatus of claim 1, wherein the hardware information comprises an encryption key stored in an integrated circuit of the reference device.

4. The apparatus of claim 3, wherein the encryption key is symmetric.

5. The apparatus of claim 1, wherein an algorithm used to encrypt the entropy is compliant with Federal Information Processing Standards (FIPS).

6. The apparatus of claim 1, wherein the at least one processor is configured to:
generate a private key and a public key based on the entropy based on providing the entropy to a random number generator of the reference device.

7. The apparatus of claim 6, wherein the private key and the public key comprise Module-Lattice Key Encapsulation Mechanism (ML-KEM) lattices.

8. The apparatus of claim 1, wherein the at least one processor is configured to:
receive group information including the hardware information.

9. The apparatus of claim 1, wherein the entropy comprises a pair of entropy values.

10. The apparatus of claim 9, wherein the entropy values are smaller than Module-Lattice Key Encapsulation Mechanism (ML-KEM) lattices.

11. An apparatus for generating private keys based on encrypted entropy information, comprising:
at least one memory; and
at least one processor coupled to the at least one memory and configured to:
receive, by a peer device, a message including encrypted entropy;
decrypt entropy from the encrypted entropy using hardware information of the peer device; and
generate a private key based on the entropy.

12. The apparatus of claim 11, wherein the at least one processor is configured to:
communicate with a plurality of peer devices based on at least one of a public key and the private key, wherein each of the plurality of peer devices includes the hardware information.

13. The apparatus of claim 11, wherein the hardware information includes an encryption key stored in an integrated circuit of the peer device.

14. The apparatus of claim 13, wherein the encryption key is symmetric.

15. The apparatus of claim 11, wherein an algorithm used to decrypt the encrypted entropy is compliant with Federal Information Processing Standards (FIPS).

16. The apparatus of claim 11, wherein the at least one processor is configured to:
provide the entropy to a random number generator of the peer device.

17. The apparatus of claim 11, wherein the private key and a corresponding public key comprise Module-Lattice Key Encapsulation Mechanism (ML-KEM) lattices.

18. The apparatus of claim 17, wherein the at least one processor is configured to:
receive group information identifying the hardware information.

19. The apparatus of claim 18, wherein the entropy comprises a pair of entropy values.

20. The apparatus of claim 19, wherein the entropy values are smaller than Module-Lattice Key Encapsulation Mechanism (ML-KEM) lattices.
